(19) United States
(12) Patent Application Publication
(10) Pub. No.: US 2025/0289768 A1
(43) Pub. Date: Sep. 18, 2025

(54) CERAMIC THERMAL SPRAY COATING MATERIAL AND METHOD FOR MANUFACTURING OF THE SAME

(71) Applicant: MiCo LTD., Anseong-si (KR)

(72) Inventors: Sung Yong KIM, Anseong-si (KR); Hee Jin JO, Anseong-si (KR); Jung Hyun IN, Anseong-si (KR)

(21) Appl. No.: 18/970,941

(22) Filed: Dec. 6, 2024

(30) Foreign Application Priority Data
Mar. 15, 2024 (KR) 10-2024-0036410

(51) Int. Cl. C04B 41/00; C23C 4/10; C23C 4/134

(52) U.S. Cl. CPC C04B 41/009; C04B 41/0072; C23C 4/10; C23C 4/134

(57) ABSTRACT

A ceramic thermal spray coating material and a method of preparing a ceramic thermal spray coating material are disclosed. The ceramic thermal spray coating material comprises a ceramic granule powder and an organic compound containing stearic acid having an ammonium group, which is modified on the surface of the ceramic granule powder. Further, the method includes: preparing ceramic granule powders; adding stearic acid having an ammonium group and the ceramic granule powders to a first solvent to prepare a first mixed solution; evaporating the first solvent from the first mixed solution; and modifying a surface of the ceramic granule powders with an organic compound by evaporating the first solvent.

### CROSS-REFERENCE TO RELATED APPLICATION

This application claims priority to and the benefit of Korean Patent Application No. 10-2024-0036410 filed in the Korean Intellectual Property Office on Mar. 15, 2024, the entire contents of which are incorporated herein by reference.

### BACKGROUND OF THE DISCLOSURE

### 1. Field of the Disclosure

The present invention relates to a ceramic thermal spray coating material and a method of preparing the same.

### 2. Description of the Related Art

Thermal spray coating using ceramic powders of single or composite materials is applied in various fields. The thermal spray coating market is segmented by many companies, and recently, the demand for coating is also increasing in the aerospace and automobile industries. In particular, in the semiconductor component field, due to the microminiaturization of semiconductors, dense density and a certain level of roughness of the coating layer are required.

In order to meet the characteristics required by the industry, the characteristics of the ceramic material used for coating should also be diversified. When coating with ceramic granule powders of about 30 to 50 μm, powders of about 30 μm or less should be secured to compensate for the increase in defects in the coating, and in order to form a uniform film, it may be necessary to minimize the span value ((D90−D10)/D50) indicating the distribution width of the sample during particle size analysis.

In the thermal spray coating method, a smooth and constant supply speed of the thermal spray powder supply section is required for the formation of a uniform film and efficient process operation. In order to ensure uniform supply, the agglomeration of powder should be minimized to increase fluidity. This is required not only for coating but also to increase the filling rate of granular powder used in the manufacture of sintered bodies. Therefore, research has been conducted continuously to secure the fluidity of ceramic powder. When the particle size is reduced to 30 μm or less, the surface energy between particles increases, causing small particles to clump together and reducing fluidity. This not only slows down the process speed, but also causes blockage of the conveying pipe and reduces the feeding amount, lowering production efficiency.

Currently, a method of improving fluidity is applied by plasma treatment of the surface. This method not only has high process installation costs but also requires a lot of energy. Instead of the plasma treatment method, a method of coating general stearic acid is emerging. However, when general stearic acid is used, uniform coating is impossible and the process cannot be performed at room temperature. In addition, when the process is carried out at a temperature of about 60° C. or higher and general stearic acid is coated, its residue may remain, which may reduce fluidity and exhibit a tendency to coagulate. Therefore, research is needed on a surface treatment method that can achieve continuous effects even with simple processes.

### PRIOR ART DOCUMENT

### Patent Document

Korean Patent 10-2302317

### SUMMARY OF THE DISCLOSURE

An object of the present invention is to provide a ceramic thermal spray coating material having improved fluidity and having almost no residue on the surface.

Another object of the present invention is to provide a method of preparing the ceramic thermal spray coating material.

In order to achieve the above object, the present invention provides a ceramic thermal spray coating material comprising: a ceramic granule powder; and an organic compound modified on a surface of the ceramic granule powder, wherein the organic compound comprises stearic acid having an ammonium group.

According to an embodiment of the present invention, the organic compound may be included in a weight ratio of 0.1 to 5.

According to an embodiment of the present invention, the ceramic granule powder may comprise at least one selected from the group consisting of Y₂O₃, YF₃, YSZ, YOF, Y₄Al₂O₉, Y₃Al₅O₁₂ and YAlO₃.

According to an embodiment of the present invention, the ceramic granule powder may be aggregates of raw material powders having a particle size of more than 0 and less than 1 μm.

According to an embodiment of the present invention, the ceramic granule powder may have a median particle size (D50) of 5 to 25 μm.

According to an embodiment of the present invention, the ceramic granule powder has particle size distribution width (Span, (D90−D10)/D50) of 0.5 to 4.

According to an embodiment of the present invention, the stearic acid having an ammonium group can be decomposed at 200 to 400° C.

In addition, the present invention provides a method of preparing a ceramic thermal spray coating material, comprising: preparing ceramic granule powders; adding stearic acid having an ammonium group and the ceramic granule powders to a first solvent to prepare a first mixed solution; evaporating the first solvent from the first mixed solution; and modifying a surface of the ceramic granule powders with an organic compound by evaporating the first solvent.

According to an embodiment of the present invention, the step of preparing the ceramic granule powders comprises: spraying composition containing ceramic raw material powders with a spray dryer to form aggregates of the ceramic raw material powders; and heat-treating the aggregate at 800 to 1400° C.

According to an embodiment of the present invention, in the step of preparing a first mixed solution by adding stearic acid having an ammonium group and the ceramic granule powders to a first solvent, molecular weight of the stearic acid having an ammonium group is 200 to 400 g/mol.

According to an embodiment of the present invention, the step of evaporating the first solvent from the first mixed solution may be performed by evaporating the first solvent using a spray dryer.

According to an embodiment of the present invention, the disk rotation speed of the spray dryer may be 6,000 to 15,000 RPM.

In addition, the present invention provides a method of preparing a ceramic thermal spray coating material, comprising: preparing a ceramic granule powders; adding stearic acid having an ammonium group to a second solvent to produce a second mixed solution; introducing the ceramic granule powders and the second mixed solution into a fluidized bed dryer; and modifying a surface of the ceramic granule powders with an organic compound in the fluidized bed dryer.

According to an embodiment of the present invention, the step of introducing the ceramic granule powders and the second mixed solution into a fluidized bed dryer is performed by introducing the ceramic granule powders into a first feeder of the fluidized bed dryer, and introducing the second mixed solution into a second feeder of the fluidized bed dryer.

### BRIEF DESCRIPTION OF THE DRAWINGS

FIG. 1 is a flow chart for explaining a method of preparing a ceramic thermal spray coating material according to an embodiment of the present invention.

FIG. 2 is a schematic diagram for explaining a method of preparing a ceramic thermal spray coating material according to an embodiment of the present invention.

FIG. 3 is a flow chart for explaining a method of preparing a ceramic thermal spray coating material according to another embodiment of the present invention.

FIGS. 4A and 4B shows results of measurement by a thermogravimetric analyzer (TGA, universal v4.5a ta instruments) of a ceramic thermal spray coating material according to an embodiment of the present invention.

FIGS. 5A and 5B shows a spectrum obtained by a Fourier transform infrared (FT-IR) spectrometer of a ceramic thermal spray coating material according to an embodiment of the present invention.

FIG. 6 shows a repose angle measurement result according to an embodiment of the present invention.

FIG. 7 shows a scanning electron microscope (SEM) image according to an embodiment of the present invention.

### DETAILED DESCRIPTION OF THE EMBODIMENTS

Hereinafter, examples of the present invention will be described in detail with reference to the attached drawings. The present invention can be modified in various ways and can have various forms, and thus specific examples are illustrated in the drawings and described in detail in the text. However, it is not intended to limit the present invention to a specific disclosed form, but should be understood to include all modifications, equivalents, or substitutes included in the spirit and technical scope of the present invention. In describing each drawing, similar reference numerals are used for similar components. In the attached drawings, the dimensions of structures are illustrated larger than actual dimensions in order to ensure clarity of the present invention.

The terms such as first, second, etc. may be used to describe various components, but the components should not be limited by the terms. The terms are used only for the purpose of distinguishing one component from another. For example, without departing from the scope of the present invention, the first component may be referred to as the second component, and similarly, the second component may also be referred to as the first component.

The terminology used in the present invention is only used to describe specific examples and is not intended to limit the present invention. The singular expression includes the plural expression unless the context clearly indicates otherwise. In this application, it should be understood that the terms “comprise” or “have” and the like are intended to specify the presence of a feature, number, step, operation, component, part, or combination thereof described in the specification, but do not exclude in advance the possibility of the presence or addition of one or more other features, numbers, steps, operations, components, parts, or combinations thereof.

Meanwhile, unless otherwise defined, all terms used herein, including technical or scientific terms, have the same meaning as commonly understood by a person of ordinary skill in the art to which the present invention belongs. Terms defined in commonly used dictionaries, such as those defined in common dictionaries, should be interpreted as having a meaning consistent with the meaning they have in the context of the relevant art, and shall not be interpreted in an idealized or overly formal sense, unless explicitly defined in this application.

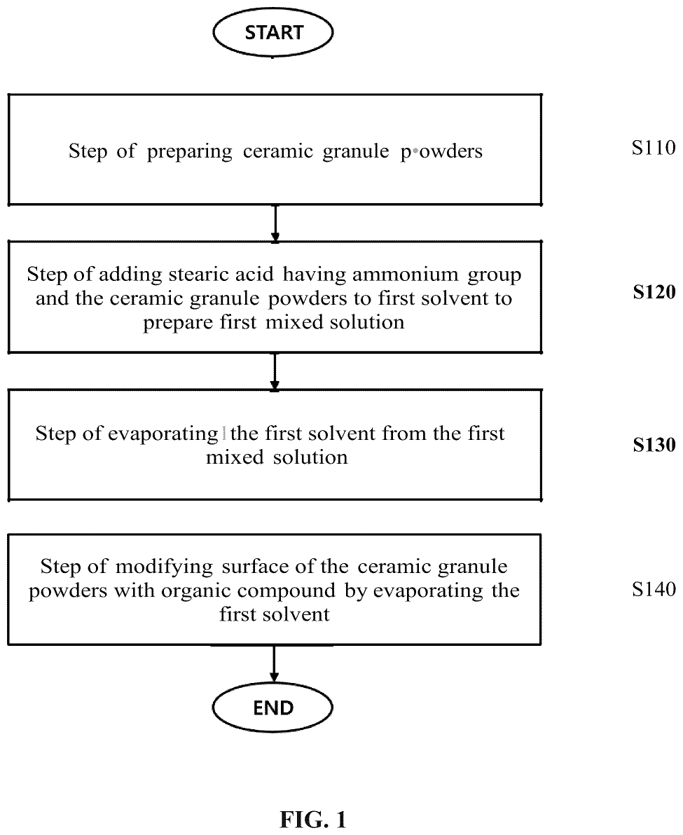

FIG. 1 is a flow chart for explaining a method of preparing a ceramic thermal spray coating material according to an embodiment of the present invention.

Referring to FIG. 1, a method of preparing a ceramic thermal spray coating material according to an embodiment of the present invention may comprise a first step (S110) of preparing ceramic granule powders; a second step (S120) of preparing a first mixed solution by adding stearic acid having an ammonium group and the ceramic granule powders to a first solvent; a third step (S130) of evaporating the first solvent from the first mixed solution; and a fourth step (S140) of modifying the surface of the ceramic granule powders with an organic compound by evaporating the first solvent.

In the first step (S110), the ceramic granule powders can be manufactured through a step of forming aggregates of the ceramic raw material powders by spraying composition containing ceramic raw material powders with a spray dryer; and a step of heat-treating the aggregates at about 800 to 1400° C. In one embodiment, the ceramic granule powder having a median particle size (D50) of about 5 to 25 μm can be prepared by spraying a composition containing the ceramic raw material powders having a particle size of about 1 μm or less with the spray dryer. The ceramic granule powders may include any one or more selected from the group consisting of Y₂O₃, YF₃, YSZ, YOF, Y₄Al₂O₉, Y₃Al₅O₁₂ and YAlO₃, but is not limited to. For example, Y₂O₃ can be used as the ceramic granule powders.

In the second step (S120), the first solvent may include at least one selected from the group consisting of water, methanol, ethanol, toluene, and IPA, but is not limited thereto. For example, ethanol may be used as the first solvent. In one embodiment, the stearic acid having the ammonium group and the ceramic granule powder may be added at a weight ratio of about 1:100 to 250 into the first solvent.

In the third step (S130), the first solvent can be evaporated by a spray dryer, and the disk rotation speed of the spray dryer can be about 6,000 to 15,000 RPM. If the disk rotation speed of the spray dryer exceeds about 15,000 RPM, the amount of particles colliding with the inner wall of the spray dryer chamber can increase. If the disk rotation speed of the spray dryer is less than about 6,000 RPM, the drying time can increase.

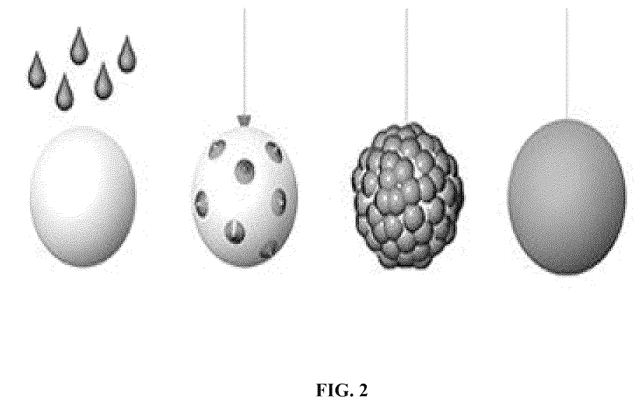

In the fourth step (S140), as shown in the schematic diagram of FIG. 2, stearic acid having an ammonium group can be coated on the surface of the ceramic granule powder as the first solvent evaporates.

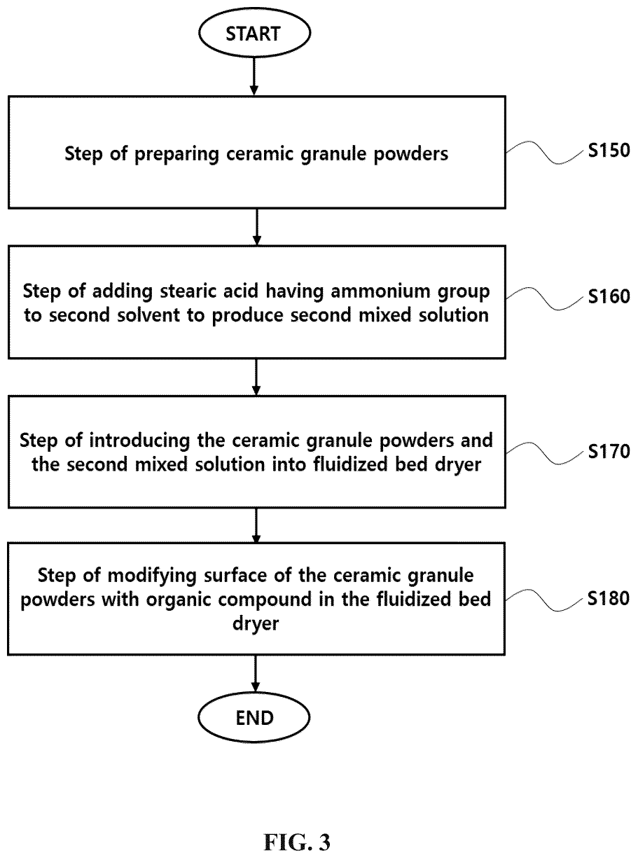

FIG. 3 is a flow chart for explaining a method of preparing a ceramic thermal spray coating material according to another embodiment of the present invention.

Referring to FIG. 3, a method of preparing a ceramic thermal spray coating material according to another embodiment of the present invention may comprise a fifth step (S150) of preparing ceramic granule powders; a sixth step (S160) of adding stearic acid having an ammonium group to a second solvent to prepare a second mixed solution; a seventh step (S170) of introducing the ceramic granule powders and the second mixed solution into a fluidized bed dryer; and an eighth step (S180) of modifying the surface of the ceramic granule powders with an organic compound in the fluidized bed dryer.

In the first step (S150), the ceramic granule powders can be manufactured through a step of forming aggregates of the ceramic raw material powders by spraying composition containing ceramic raw material powders with a spray dryer; and a step of heat-treating the aggregates at about 800 to 1400° C. In one embodiment, the ceramic granule powder having a median particle size (D50) of about 5 to 25 μm can be prepared by spraying a composition containing the ceramic raw material powders having a particle size of about 1 μm or less with the spray dryer. The ceramic granule powders may include any one or more selected from the group consisting of Y₂O₃, YF₃, YSZ, YOF, Y₄Al₂O₉, Y₃Al₅O₁₂ and YAlO₃, but is not limited to. For example, Y₂O₃ can be used as the ceramic granule powders.

In the above sixth step (S160), the molecular weight of the stearic acid having the ammonium group may be about 200 to 400 g/mol, but is not limited thereto.

In one embodiment, the second solvent may include at least one selected from the group consisting of water, methanol, ethanol, toluene, and IPA. For example, ethanol may be used as the second solvent. In one embodiment, the stearic acid having the ammonium group and the ceramic granule powders may be introduced at a weight ratio of about 1:100 to 250 into the first solvent.

In the above seventh step (S170), the ceramic granule powder may be introduced into the first feeder of the fluidized bed dryer, and the second mixed solution may be introduced into the second feeder of the fluidized bed dryer. The first feeder may be a top feeder, and the second feeder may be a bottom feeder.

In the eighth step (S180), the second mixed solution fed into the second feeder may flow to coat the surface of the ceramic granule powder with an organic compound.

The ceramic thermal spray coating material according to the present invention can be manufactured by the above manufacturing method, and can comprise a ceramic granule powder; and an organic compound modified on the surface of the ceramic granule powder, wherein the organic compound comprises stearic acid having an ammonium group.

In one embodiment, the organic compound can be included in a weight ratio of about 0.1 to 5 based on the weight of the ceramic granule powder. If the weight ratio of the organic compound is less than about 0.1, the organic compound may not be uniformly modified on the surface of the ceramic granule powder. If the weight ratio of the organic compound exceeds about 5, the ceramic granule powder may be over-agglomerated by the organic compound.

In one embodiment, the ceramic granule powder may include any one or more selected from Y₂O₃, YF₃, YSZ, YOF, Y₄Al₂O₉, Y₃Al₅O₁₂ and YAlO₃, but is not limited thereto. For example, Y₂O₃ can be used as the ceramic granule powder.

In one embodiment, the ceramic granule powder can be aggregates of raw material powders having a particle size of more than 0 and less than or equal to 1 μm. When the size of the raw material powder exceeds about 1 μm, the roughness value of the ceramic granule powder can increase.

In one embodiment, the median particle size (D50) of the ceramic granule powder can be about 5 to 25 μm, and the particle size distribution width (Span, (D90−D10)/D50) of the ceramic granule powder can be about 0.5 to 4. When the particle size distribution width of the ceramic granule powder exceeds about 4, a uniform film may not be formed during thermal spray coating.

Hereinafter, the present invention will be described in more detail through examples. These examples are intended to explain the present invention in more detail, and the scope of the present invention is not limited to these examples. The examples of the present invention are provided to more completely explain the present invention to a person having average knowledge in the art.

### Example 1

Y₂O₃ selected as having an average particle size of about 20 μm or less was prepared by heat treatment at about 800 to 1400° C. Stearic acid (about 2.5 g, about 0.5 wt %) containing an ammonium group and the Y₂O₃ (about 500 g) were added to ethanol (about 380 ml) and stirred to prepare a first mixed solution. The first mixed solution was put into a spray dryer to evaporate the solvent of the first mixed solution. The disk rotation speed of the spray dryer was set to about 6,000 to 15,000 RPM. A ceramic thermal spray coating material was prepared by coating Y₂O₃ with an organic compound in the spray dryer.

### Example 2

A ceramic thermal spray coating material was manufactured in the same manner as in Example 1, except that about 5 g (about 1 wt %) of the stearic acid containing the ammonium group was used in Example 1.

### Example 3

A ceramic thermal spray coating material was prepared in the same manner as in Example 1, except that about 10 g (about 2 wt %) of the stearic acid containing the ammonium group was used in Example 1.

### Example 4

A ceramic thermal spray coating material was prepared in the same manner as in Example 1, except that about 25 g (about 5 wt %) of the stearic acid containing the ammonium group was used in Example 1.

### Example 5

Y₂O₃ selected as having an average particle size of about 20 μm or less was prepared by heat treatment at about 800 to 1400° C. Stearic acid containing an ammonium group (about 2.5 g, about 0.5 wt %) was added to ethanol (about 380 ml) and stirred to prepare a second mixed solution. The second mixed solution was fed into the bottom feeder of the fluidized bed dryer, and the Y₂O₃ (about 500 g) was fed into the top feeder of the fluidized bed dryer. A ceramic thermal spray coating material was manufactured by coating an organic compound on the Y₂O₃ through the fluidized bed dryer.

### Comparative Example 1

Commercial Y₂O₃ was prepared.

### Comparative Example 2

Instead of the stearic acid containing the ammonium group used in Example 1, general stearic acid (about 10 g) was used, and a ceramic thermal spray coating material was prepared in the same manner as in Example 1, except that the temperature of the spray dryer was set to about 90° C.

### Comparative Example 3

A ceramic thermal spray coating material was prepared in the same manner as in the Example 1, except that about 30 g (about 6 wt %) of the stearic acid containing an ammonium group in the Example 1 was used.

### Comparative Example 4

A ceramic thermal spray coating material was prepared in the same manner as in the Example 1, except that about 35 g (about 7 wt %) of the stearic acid containing an ammonium group in the Example 1 was used.

### Experimental Example 1

Table 1 below summarizes the density and angle of repose of Examples 3 and 5 to confirm the difference in properties due to the manufacturing equipment of the ceramic thermal spray coating material. The density and angle of repose were measured according to ASTM D6393-08. The apparent density was measured by dropping the powder through a funnel of about 6 to 8 mm and placing it in a container of a certain volume (about 25 ml), and the angle of inclination (angle of repose) at which the falling powder was piled up on a disc and stabilized was measured. As shown in Table 1, Example 3 was manufactured using a spray dryer, and Example 5 was manufactured using a fluidized bed dryer. Despite the difference in manufacturing equipment, ceramic thermal spray coating materials with very similar properties were manufactured.

TABLE 1

| | Example 3 | Example 5 |
|---|---|---|
| Density (g/cm³) | 1.57 | 1.51 |
| Angle of repose (°) | 28.78 | 29.02 |

Table 2 below summarizes the density and angle of repose of Examples 1 to 4, Comparative Examples 1, 3, and 4 in order to confirm the change in physical properties according to the addition ratio of stearic acid including an ammonium group. The angle of repose of the Comparative Example was 35° or more, and the angle of repose of Examples 1 to 4 was measured to be 35° or less. It was confirmed through the angle of repose that the fluidity of Examples 1 to 4 was excellent. Through this, it was confirmed that when the addition content of stearic acid including an ammonium group was about 0.1 to 5 wt %, granular powder was formed by the ammonium group, thereby increasing the fluidity.

TABLE 2

| | Added content | | | Whether coating |
|---|---|---|---|---|
| | of stearic acid | | | can be applied (∘ |
| | containing | | Angle | Suitable, Δ |
| | ammonium | Apparent | of | Suitable under |
| | group | density | repose | certain conditions, |
| | (weight %) | (g/cm³) | (°) | x Unsuitable) |
| Comparative | 0 | 1.272 | 41.07 | x |
| Example 1 | | | | |
| Example 1 | 0.5 | 1.45 | 33.24 | ∘ |
| Example 2 | 1 | 1.47 | 29.83 | ∘ |
| Example 3 | 2 | 1.57 | 28.78 | ∘ |
| Example 4 | 5 | 1.49 | 32.1 | ∘ |
| Comparative | 6 | 1.32 | 39.3 | Δ |
| Example 3 | | | | |
| Comparative | 7 | 1.21 | 40.27 | x |
| Example 4 | | | | |

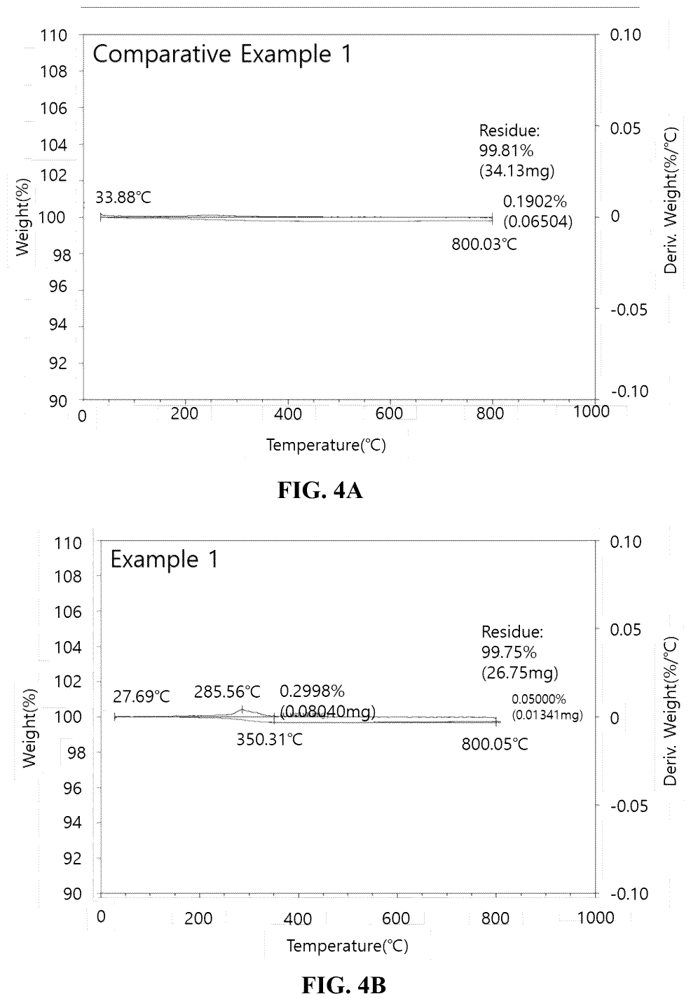

FIG. 4B is a result of measuring the thermogravimetric analyzer (TGA, universal v4.5a ta instruments) of a ceramic thermal spray coating material according to an example of the present invention. The weight change at about 30 to 800° C. was analyzed. In Comparative Example 1, there was almost no change in mass in the measurement temperature range. In Example 3, a slight weight change of about 0.3% was observed near about 285° C. This was due to stearic acid containing an ammonium group, and it was confirmed that the stearic acid containing the ammonium group was decomposed above about 350° C.

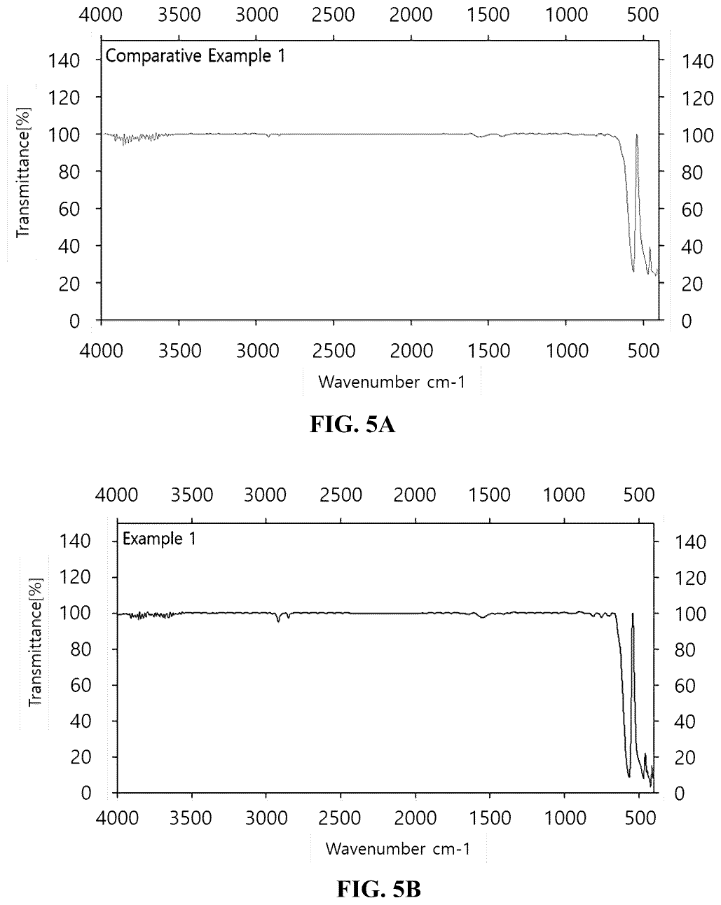

FIG. 5B is a Fourier transform infrared (FT-IR) spectrometer (VERTEX 70V) spectrum of a ceramic thermal spray coating material according to an example of the present invention. Measurements were performed over a wavelength range of approximately 368 to 4000 cm⁻¹. In Example 3, a slightly clearer peak was observed at about 2800 to 3000 cm⁻¹ and about 1200 to 1800 cm⁻¹ than in Comparative Example 1. The above peak is a peak related to an organic compound, and it was confirmed through FT-IR that an organic compound was present in Example 3.

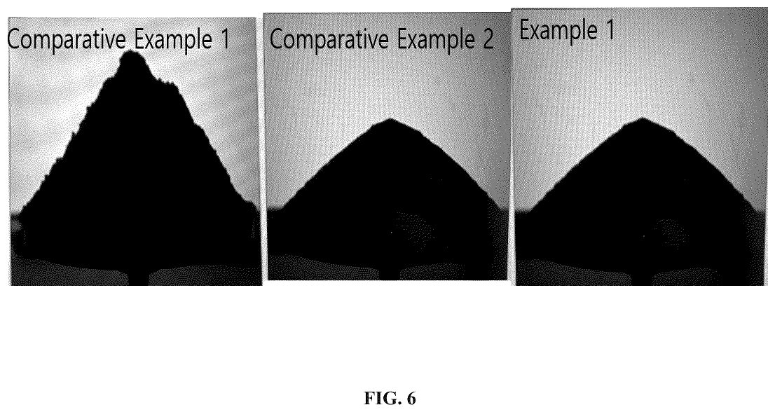

FIG. 6 is a result of measuring the angle of repose of a ceramic thermal spray coating material according to an example of the present invention. The angle of repose of Comparative Example 1 was confirmed to be about 41.07°, the angle of repose of Comparative Example 2 was confirmed to be about 38.8°, and the angle of repose of Example 3 was confirmed to be about 28.78°. The angle of repose of Example 3 was determined to be 35° or less, indicating excellent fluidity. It was determined that Comparative Example 2 had a high angle of repose because it was difficult to form a granular powder by clumping together the powders using general stearic acid without ammonium group. The apparent density of Comparative Example 1 was confirmed to be about 1.272 g/cm³, the apparent density of Comparative Example 2 was confirmed to be about 1.37 g/cm³, and the apparent density of Example 3 was confirmed to be about 1.57 g/cm³. The apparent density is a filling ratio according to fluidity, and it was expected that Example 3 would have a higher filling ratio than Comparative Examples 1 and 2.

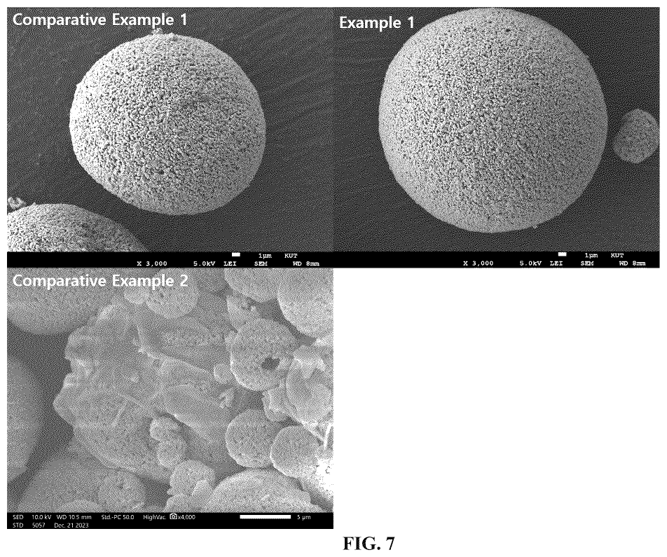

FIG. 7 is a scanning electron microscope (SEM, JEOL Ltd., JSM-7500F, JSM-IT200) image of a ceramic thermal spray coating material according to an example of the present invention. It was confirmed that Comparative Example 1 was about 24 μm and Example 1 was about 28 μm. Through this, it was confirmed that Example 3 had a granular form of about 30 μm or less. It was observed that some of the organic compounds on the surface of Comparative Example 2 were not uniform, but Example 3 was confirmed to have almost no residue on the surface. Through this, it was expected that Example 3 would have improved flowability and reduced agglomeration tendency compared to Comparative Example 2.

The physical properties of the examples according to the present invention are summarized in Table 3 below. The porosity was analyzed using the image analysis software Image Pro Plus (MediaCybernetics), and the hardness was measured using a hardness tester (Mitutoyo, HM 810-124K), and the roughness was measured using a surface roughness tester (Mitutoyo, SJ-210). In Example 3, the porosity and roughness values decreased compared to Comparative Example 2 due to the organic compound, and the hardness increased compared to Comparative Example 2. Through this, it was confirmed that the organic compound improved the properties of the existing ceramic coating material.

TABLE 3

| | unit | Comparative Example 2 | Example 3 |
|---|---|---|---|
| Porosity | % | 3 to 6 | Less than 1.0 |
| Hardness | Hv | 400 to 450 | 500 to 600 |
| Roughness | μm | 4.6 to 5.3 | 2.6 to 3.2 |

According to the present invention, when comparing the same granular powder produced under certain conditions before and after surface treatment, the result values of increased density and decreased angle of repose due to improved filling ratio compared to before surface treatment can have an effect of improved fluidity. In addition, a continuous effect can be expected with a simple process without using a surface treatment method such as plasma treatment. By improving fluidity, uniform feeding is possible even for small particles, so that required coating properties such as high density and roughness control can be obtained.

While the present invention has been particularly described with reference to specific embodiments thereof, it is apparent that this specific description is only a preferred embodiment and that the scope of the present invention is not limited thereby to those skilled in the art. That is, the practical scope of the present invention is defined by the appended claims and their equivalents.

What is claimed is:

1. A ceramic thermal spray coating material comprising:
a ceramic granule powder; and
an organic compound modified on a surface of the ceramic granule powder,
wherein the organic compound comprises stearic acid having an ammonium group which is included in a weight ratio of 0.1 to 5.

2. The ceramic thermal spray coating material of claim 1, wherein the ceramic granule powder comprises at least one selected from the group consisting of Y₂O₃, YF₃, YSZ, YOF, Y₄Al₂O₉, Y₃Al₅O₁₂ and YAlO₃.

3. The ceramic thermal spray coating material of claim 2, wherein the ceramic granule powder is aggregates of raw material powders having a particle size of more than 0 and less than 1 μm.

4. The ceramic thermal spray coating material of claim 3, wherein the ceramic granule powder has a median particle size (D50) of 5 to 25 μm.

5. The ceramic thermal spray coating material of claim 4, wherein the ceramic granule powder has particle size distribution width (Span, (D90−D10)/D50) of 0.5 to 4.

6. The ceramic thermal spray coating material of claim 1, wherein the stearic acid having an ammonium group is decomposed at 200 to 400° C.

7. A method of preparing a ceramic thermal spray coating material, comprising:
preparing ceramic granule powders;
adding stearic acid having an ammonium group which is included in a weight ratio of 0.1 to 5 and the ceramic granule powders to a first solvent to prepare a first mixed solution;
evaporating the first solvent from the first mixed solution; and
modifying a surface of the ceramic granule powders with an organic compound by evaporating the first solvent.

8. The method of preparing a ceramic thermal spray coating material of claim 7, wherein preparing the ceramic granule powders comprises:
spraying composition containing ceramic raw material powders with a spray dryer to form aggregates of the ceramic raw material powders; and
heat-treating the aggregates at 800 to 1400° C.

9. The method of preparing a ceramic thermal spray coating material of claim 7, wherein in preparing a first mixed solution by adding stearic acid having an ammonium group and the ceramic granule powders to a first solvent, molecular weight of the stearic acid having an ammonium group is 200 to 400 g/mol.

10. The method of preparing a ceramic thermal spray coating material of claim 7, wherein evaporating the first solvent from the first mixed solution is performed by evaporating the first solvent using a spray dryer.

11. The method of preparing a ceramic thermal spray coating material of claim 10, wherein disk rotation speed of the spray dryer is 6,000 to 15,000 RPM.

12. A method of preparing a ceramic thermal spray coating material, comprising:
preparing ceramic granule powders;
adding stearic acid having an ammonium group to a second solvent to produce a second mixed solution, the stearic acid being included in a weight ratio of 0.1 to 5;
introducing the ceramic granule powders and the second mixed solution into a fluidized bed dryer; and
modifying a surface of the ceramic granule powders with an organic compound in the fluidized bed dryer.

13. The method of preparing a ceramic thermal spray coating material of claim 12, introducing the ceramic granule powders and the second mixed solution into a fluidized bed dryer is performed by introducing the ceramic granule powders into a first feeder of the fluidized bed dryer, and introducing the second mixed solution into a second feeder of the fluidized bed dryer.
